(19) United States
(12) Patent Application Publication
(10) Pub. No.: US 2020/0095814 A1
(43) Pub. Date: Mar. 26, 2020

(54) VEHICLE CONSOLE HAVING A CONSOLE DOOR GAP HIDING MOLDING STRIP

(71) Applicant: GM Global Technology Operations LLC, Detroit, MI (US)

(72) Inventor: Timothy Kiester, Orion, MI (US)

(21) Appl. No.: 16/138,023

(22) Filed: Sep. 21, 2018

(51) Int. Cl. E05D 11/00; B60R 7/04; B60R 13/02; E05D 3/02

(52) U.S. Cl. CPC E05D 11/0054; B60R 7/04; E05D 2011/0072; E05D 3/02; E05Y 2900/538; B60R 13/02

(57) ABSTRACT

A console for a vehicle is provided. The console includes a console base having a perimeter surface defining a storage bin, wherein a side of the perimeter surface defines a channel; a console lid pivotable in first position and in a second position, the console lid includes a pivotal end disposed adjacent the channel; a floating trim strip slidably disposed within the channel; and a biasing member disposed within the channel urging the trim slide outward of the channel making contact with the pivotal end. The pivot end defines a cam surface having a cam profile and the molding strip includes a cam follower surface configured to slidingly engage the cam surface. The cam profile cooperates with the biasing member such that the molding strip maintain continuous contact with the pivotal end thus hiding a gap between the console base and console lid.

### INTRODUCTION

The present disclosure relates generally to a console for motor vehicles, and more specifically, to a console having a door gap hider.

Motor vehicles typically include a center console disposed in the passenger compartment between the driver and front passenger seats. A center console typically includes a console base secured to the floor between the driver and front passenger seats, a storage bin formed in the console base, and a console lid pivotally connected to the console base for selectively covering the storage bin. The console lid, also known as a console door, is selectively pivotable between a first position, closed position, in which the lid covers an opening to the storage bin and a second position, open position, wherein the console lid extends angularly away from the console to permit access to the storage bin.

In the closed position, the console lid is in a substantially horizontal orientation convenient for the driver and/or passenger to rest their arms. The console lid may be pivotally hinged on a longitudinal side of the console base, extending from the front to the rear of the motor vehicle, or pivotally hinged on a latitudinal side of the console base, extending from the driver to the passenger side of the motor vehicle. For consoles in more up-market motor vehicles, the console lid may be longitudinally divided into a first and second door panels and each of the panels is individually pivotally hinged on opposite longitudinal sides of the floor console. The double door panel lids are also known as bomb-bay doors or bombay doors.

In consoles with longitudinally hinges, where the hinges are hidden within the console base and console lid, a gap is defined between an exterior surface of the console base and console lid to allow for clearance for the pivoting of the console lid between the open and closed positions. While the width of the gap is minimal, usually in the 2 to 5 mm range, the visual perception of the gap may be magnitudes larger resulting unpleasing visual aesthetic of the center console. This is particularly undesirable for center consoles having bomb-bay type doors, since there is a gap on each of the driver and passenger sides.

Thus, while center consoles having longitudinally pivotable console lids achieve their intended purpose, there is a need to reduce or eliminate the gap between the console base and console lid to improve the visual aesthetics and perceived quality of the center console.

### SUMMARY

According to several aspects, a console for a vehicle is provided. The console includes a console base defining a storage bin, a console lid having a pivotal end hinged to a side of the console base adjacent to the storage bin, a gap defined between the pivotal end and console base to allow for sufficient clearance space for the pivotal end to pivot between a first position and a second position, a channel defined in the side of the console base adjacent to the pivotal end of the console lid, a floating molding strip disposed within the channel, and a biasing member urging the floating molding strip to extend from the channel into the gap making contact with the pivotal end, thus visually hiding the gap.

In an additional aspect of the present disclosure, the pivotal end includes a cam surface and the floating molding strip includes a cam follower surface slidable engaged to the cam surface when the pivotal end is pivoted between the first position and second position.

In another aspect of the present disclosure, the cam surface defines a cam profile that cooperates with the biasing member such that the floating molding strip maintains continuous contact with the pivotal end.

In another aspect of the present disclosure, the biasing member is one of a coiled spring and an elastomer member.

In another aspect of the present disclosure, the molding strip includes an exterior surface having a first portion slidably engaging a first wall of the channel and a second portion slidably engaging a second wall of the channel. The cam follower surface interconnects the first and second portions.

In another aspect of the present disclosure, molding strip includes an interior surface opposite the cam follower surface. The biasing member is disposed between a bottom wall of the channel and the interior surface of the molding strip such that the cam follower surface is urged apart from the bottom wall.

In another aspect of the present disclosure, the console further includes an exterior trim panel having an interior surface. The console base includes a perimeter surface having a contoured surface, a first vertical surface extending from the contoured surface, a horizontal surface extending from the first vertical surface, and a second vertical surface extending from the horizontal surface. The trim panel is engaged to the second vertical surface such that the interior surface of the trim panel cooperates with the horizontal surface and first vertical wall to define the channel.

In another aspect of the present disclosure, the cam surface of the pivotal end includes a horizontal surface transitioning to a vertical surface when the pivotal end is in the closed position.

In another aspect of the present disclosure, the console further includes a first hinge member extending from the console base and a second hinge member disposed within the pivotal end. The first hinge member is attached to the second hinge member such that the console lid is pivotable between the open position and closed position about a pivot axis A.

In another aspect of the present disclosure, the console further includes a second console lid thus defining a bomb-bay door.

According to several aspects, a console for a vehicle is provided. The console includes a console base having a perimeter surface defining a storage bin, wherein a side of the perimeter surface defines a channel; a console lid pivotable in first position closing the storage bin and in a second position opening the storage bin, the console lid includes a pivotal end disposed adjacent the channel; a floating trim strip slidably disposed within the channel; and a biasing member disposed within the channel urging the trim slide outward of the channel making contact with the pivotal end.

In another aspect of the present disclosure, the pivot end defines a cam surface having a cam profile and the molding strip includes a cam follower surface configured to slidingly engage the cam surface. The cam profile cooperates with the biasing member such that the molding strip maintain continuous contact with the pivotal end.

According to several aspects, the biasing member is disposed within the channel between the molding strip and a bottom wall of the channel.

In another aspect of the present disclosure, the biasing member includes at least one of a coiled spring and an elastomer material.

In another aspect of the present disclosure, the molding strip includes an external surface having a first portion and an opposite second portion slidably engaging a first and second channel wall, respectively.

In another aspect of the present disclosure, a console for a vehicle is provided. The console includes a storage bin having a perimeter surface defining an opening; a pivotable lid hinged on the storage bin proximal to a side of the perimeter surface such that a gap space is defined between the lid and the side of the perimeter surface; a channel defined along the side of the perimeter surface; a molding strip floatingly disposed within the channel; and a biasing member urging a portion of the molding strip to extend out of the channel and against the pivotable lid such that the gap space is occupied by the portion of the molding strip.

According to several aspects, the console further includes a molding panel having an interior surface cooperating with the perimeter surface to define the channel.

In another aspect of the present disclosure, the perimeter surface includes a first vertical portion transitioning to a horizontal portion transitioning to a second vertical portion, The second vertical portion engages the interior surface of the interior molding panel such that the channel is defined by first vertical portion, a portion of the interior surface facing the first vertical portion, and the horizontal portion interconnecting the first vertical portion and the portion of the interior surface.

In another aspect of the present disclosure, the lid includes a cam surface in contact with the molding strip urging the molding strip to retract into the channel as the lid is pivoted from one of a first position and a second position to the other of the first position and the second position.

According to several aspects, the biasing member is a coil spring under compression. The coil spring includes a first end engaged to the horizontal portion and an opposite second end engaging an interior surface of the molding strip.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a perspective view of an interior passenger compartment of a motor vehicle having a center console with bomb-bay door panels;

FIG. 2 is a partial cross-sectional view of the center console of FIG. 1 showing a door panel in a first position, according to an exemplary embodiment;

FIG. 3 is a partial cross-sectional view of the center console of FIG. 1 showing the door panel in a second position, according to an exemplary embodiment; and

FIG. 4 is a cut-away perspective view of the center console showing the floating molding strip, according to an exemplary embodiment.

### DETAILED DESCRIPTION

The following description is merely exemplary in nature and is not intended to limit the present disclosure, application, or uses. The illustrated embodiments are disclosed with reference to the drawings, wherein like numerals indicate corresponding parts throughout the several drawings. The figures are not necessarily to scale and some features may be exaggerated or minimized to show details of particular features. The specific structural and functional details disclosed are not intended to be interpreted as limiting, but as a representative basis for teaching one skilled in the art as to how to practice the disclosed concepts.

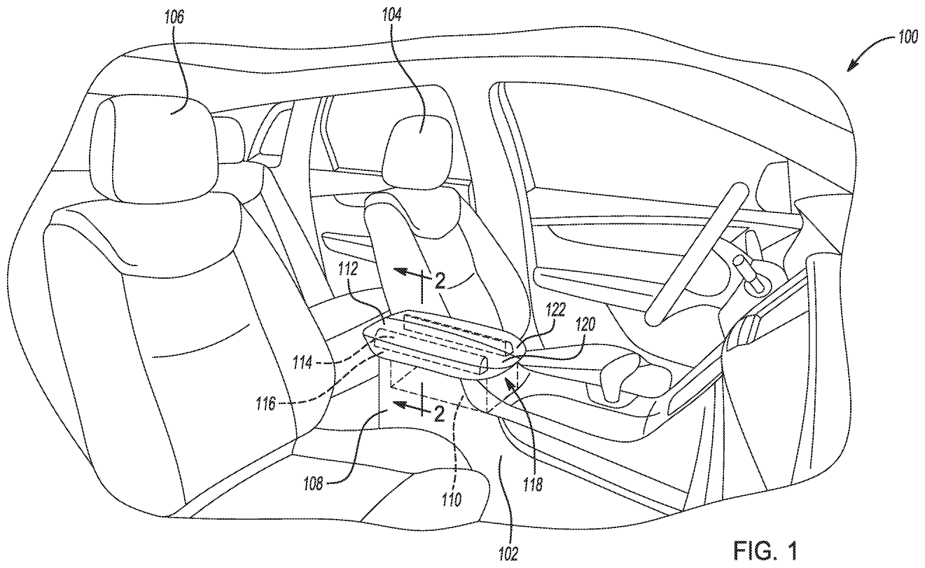

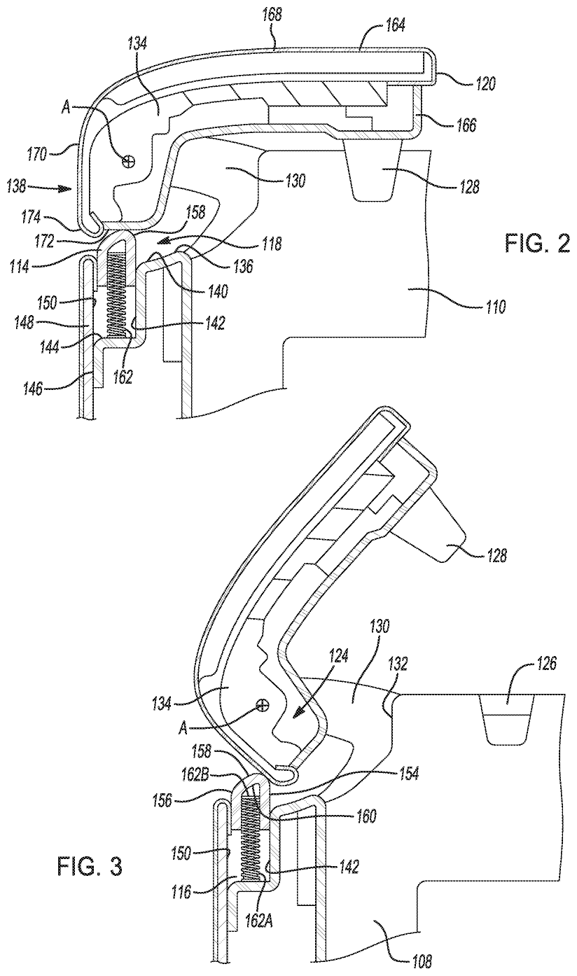

FIG. 1 shows a perspective view of an interior passenger compartment 100 of a motor vehicle. The interior passenger compartment includes a center console 102 between a driver seat 104 and a front passenger seat 106. The center console 102 includes a console base 108, a storage bin 110 defined in the console base 108, and a console lid 112 selectively covering the storage bin 110. The center console 102 also includes a floating molding strip 114 that extends outwardly from a molding channel 116 to occupy a gap 118 between the console lid 112 and console base 108, thus reducing or eliminating the visual perception of the gap 118, which is best shown in FIGS. 2 and 3. Although the exemplary center console 102 having a floating molding strip 114 is shown in an automotive passenger vehicle, the center console 102 may be used in other vehicles such as planes, boats, commercial trucks, or other suitable vehicles.

The exemplary console lid 112 is a bomb-bay type console lid 112, or also known as a bombay door, having a first door panel 120 and a second door panel 122. Each of the first and second door panels 120, 122 is pivotally connected to a respective longitudinal side of the console base 108 such that the panels 120, 122 pivot open outwardly toward the respective driver and passenger seats 104, 106, and pivot close inwardly toward the center-line of the center console 102. At least one of the door panels 120, 122 is pivotally connected to the console base 108 with a hidden hinge mechanism 124, which is best shown in FIGS. 2 and 3. Is should be appreciated that the panels doors 120 may be pivotally connected to the console base 108 in the latitudinal direction in alternative embodiments.

Referring to FIG. 2 is a partial cross-section view of the center-console along line 2-2 showing one of the door panels 120, 122, specifically door panel 120, in a closed position covering the storage bin 110. To keep the door panel 120 in the closed position, a friction or snap retainer 126 is defined in the console base 108 adjacent the storage bin 110 to engage with a corresponding tab 128 on the door panel 120. Referring to FIG. 3 is a partial cross-section view of the center-console along line 2-2 showing the door panel 120 in an open position allowing access to the storage bin 110.

Referring to both FIGS. 2 and 3, the gap 118 defined between the door panel 120 and a perimeter surface 136 adjacent the storage bin 110 provides an adequate a fixed clearance space for the door panel 120 to pivot between the closed position and the open position. However, due to the geometry of a pivotal end 138 of the door panel 120, the end portion of the door panel 120 that pivots about the A-axis, the required clearance space is not necessary constant during the pivoting motion of the door panel 120. The floating molding strip 114 cooperates with the geometry of the pivotal end 138 such that the molding strip 114 occupies the fixed clearance space not occupied by the pivotal end 138, thus visually eliminating or reducing the gap 118.

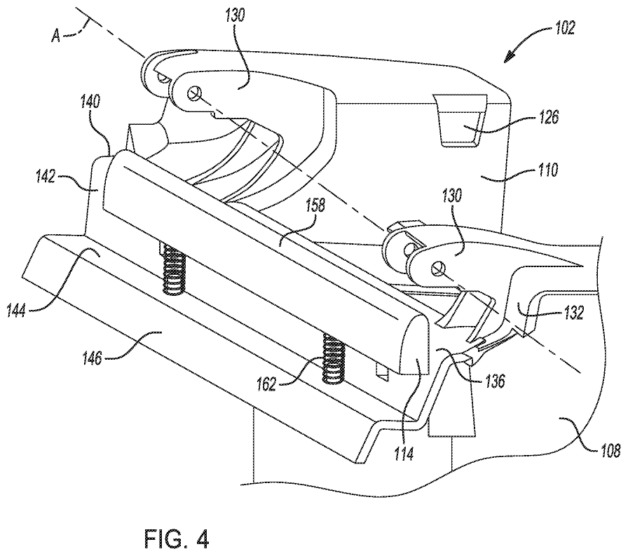

The door panel 120 is attached to the console base 108 with a hidden hinge mechanism 124. The hidden hinge mechanism 124 includes a first hinge member 130 extending from an interior surface 132 of the console base 108 and a second hinge member 134 disposed within the pivotal end 138 of the door panel 120. The first hinge member 130 is attached to the second hinge member 134 such that the door panel 120 pivots between the open position and closed position about a pivot axis A, which is best shown in FIG. 4. The interior surface 132 defines the perimeter surface 136 extending adjacent the pivotal end 138 of the door panel 120.

The perimeter surface 136 extends outwardly from the storage bin 110 and includes a contoured surface 140 conforming to a shape of the pivotal end 138 of the door panel 120, a first vertical surface 142 extending from the contoured surface 140, a horizontal surface 144 extending from the first vertical surface 142, and a second vertical surface 146 extending from the horizontal surface 144. An exterior trim panel 148 is mated against the second vertical surface 146. The exterior trim panel 148 includes an interior surface 150 cooperating with the first vertical surface 142 and the horizontal surface 144 therebetween to define the molding channel 116 having a first wall 142, a second wall 150, a bottom wall 144. The molding channel 116 extends longitudinally in the same general direction as that of the axis A.

The floating molding strip 114 is disposed within the molding channel 116. The molding strip 114 includes an external surface having a first portion 154 slidably engaging the first vertical surface 142, first channel wall, and a second portion 156 slidably engaging the interior surface 150 of the trim panel 148, second channel wall. The external surface of the molding strip 114 also includes a cam follower surface 158 between the first and second portion 154, 156, and an interior surface 160 opposite of the external surface. A biasing member 162 is disposed in the molding channel 116 urging the floating molding strip 114 apart from the horizontal surface 144 such that the cam follower surface 158 projects out of the channel 116. The biasing member 162 may be a spring, such as a compressed coiled spring having a first end 162A engaged to the horizontal surface 144 and a second opposite end 162B engaged to the interior surface 160 of the floating molding strip 114, or a resilient member formed of an elastomer material.

Referring to FIG. 2, the door panel 120 is shown in the closed position. The door panel 120 includes an interior structure defining the second hinge member 134. The door panel 120 also includes an exterior cover 164 cooperating with an interior panel 166 to encase the second hinge member 134. The exterior cover 164 includes a substantially flat horizontal surface 168 transitioning to a substantially vertical surface 170 about the pivot point, A-axis, of the hinge mechanism 124. The exterior cover 164 may be formed of a foam core surrounded by a decorative pliable skin. The interior panel 166 includes a substantially flat surface 172 transitioning to an end of the vertical surface 170 of the exterior cover 164 to define a cam surface 174. The cam surface 174 defines a cam profile that is the outline of the cross-section of the pivotal end 138 of the door panel 120.

Referring to both FIGS. 2 and 3, the biasing member 162 urges the cam follower surface 158 of the molding strip 114 against the cam surface 174 of the pivotal end 138 of the door panel 120. As the door panel 120 is pivoted between the open and closed position, the cam surface 174 of the slides on the cam follower surface 158 of the molding strip 114. The cam surface 174 cooperates with the biasing member 162 to vary the extension of the molding strip 114 out from the molding channel 116 such that the gap 118 is occupied by a portion of the molding strip 114. In other words, the cam surface 174 of the door panel 120 cooperates with the biasing member 162 to vary the extension of the molding strip 114 out of the channel 116 to visually hide the gap 118 without the molding strip 114 hampering the opening and closing of the door panel 120.

Referring to FIG. 4, is a cut-away perspective view of the center console 102 showing the floating molding strip 114. FIG. 4 shows a pair of first hinge members 130 extending from an interior surface 132 of the console base 108, the snap retainer 126 defined in the console base 108 adjacent the storage bin 110, and a perimeter surface 136 extending outwardly from the storage bin 110. The perimeter surface 136 includes a contoured surface 140, a first vertical surface 142 extending from the contoured surface 140, a horizontal surface 144 extending from the first vertical surface 142, and a second vertical surface 146 extending from the horizontal surface 144. The molding strip 114 is disposed longitudinally within the partial channel 116 defined by the first vertical surface 142 and horizontal surface 144. A compressed coil spring 162 is disposed in the channel 116. The compressed coil spring 162 includes a first end 162A engaged to the horizontal surface 144 and a second end 162 B engaged to the floating molding strip 114 urging the cam follower surface 158 out from the channel 116.

It should be appreciated that the disclosure presented herein is also applicable to the other door panel 120 and a single console lid 112 that is either longitudinally or latitudinal pivotally hinged on the console base 108, and it is not limited to consoles having bomb-bay doors. The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A console for a vehicle, comprising:
a console base defining a storage bin;
a console lid having a pivotal end hinged to a side of the console base adjacent to the storage bin;
a gap defined between the pivotal end and console base to allow for sufficient clearance space for the pivotal end to pivot between a first position and a second position;
a channel defined in the side of the console base adjacent to the pivotal end of the console lid;
a floating molding strip disposed within the channel; and
a biasing member urging the floating molding strip to extend from the channel into the gap making contact with the pivotal end, thus visually hiding the gap.

2. The console of claim 1, wherein the pivotal end includes a cam surface and the floating molding strip includes a cam follower surface slidable engaged to the cam surface when the pivotal end is pivoted between the first position and second position.

3. The console of claim 2, wherein the cam surface defines a cam profile that cooperates with the biasing member such that the floating molding strip maintains continuous contact with the pivotal end.

4. The console of claim 3, wherein the biasing member is one of a coiled spring and an elastomer member.

5. The console of claim 3, wherein the molding strip includes an exterior surface having a first portion slidably engaging a first wall of the channel and a second portion slidably engaging a second wall of the channel, and wherein the cam follower surface interconnects the first and second portions.

6. The console of claim 5, wherein the molding strip includes an interior surface opposite the cam follower surface, and wherein the biasing member is disposed between a bottom wall of the channel and the interior surface of the molding strip such that the cam follower surface is urged apart from the bottom wall.

7. The console of claim 6, further comprising an exterior trim panel having an interior surface;
wherein the console base includes a perimeter surface having a contoured surface, a first vertical surface extending from the contoured surface, a horizontal surface extending from the first vertical surface, and a second vertical surface extending from the horizontal surface, and
wherein trim panel is engaged to the second vertical surface such that the interior surface of the trim panel cooperates with the horizontal surface and first vertical wall to define the channel.

8. The console of claim 6, wherein the cam surface of the pivotal end includes a horizontal surface transitioning to a vertical surface when the pivotal end is in a closed position.

9. The console of claim 8, further comprising:
a first hinge member extending from the console base; and
a second hinge member disposed within the pivotal end;
wherein first hinge member is attached to the second hinge member such that the console lid is pivotable between an open position and the closed position about a pivot axis A.

10. The console of claim 9, further comprising a second console lid thus defining a bomb-bay door.

11. A console for a vehicle, comprising:
a console base having a perimeter surface defining a storage bin, wherein a side of the perimeter surface defines a channel;
a console lid pivotable in first position closing the storage bin and in a second position opening the storage bin, the console lid includes a pivotal end disposed adjacent the channel;
a floating trim strip slidably disposed within the channel; and
a biasing member disposed within the channel urging the trim side outward of the channel making contact with the pivotal end.

12. The console for a vehicle of claim 11, wherein:
the pivot end defines a cam surface having a cam profile, and
the floating molding strip includes a cam follower surface configured to slidingly engage the cam surface, wherein the cam profile cooperating with the biasing member such that the floating molding strip maintain continuous contact with the pivotal end.

13. The console for a vehicle of claim 12, wherein the biasing member is disposed within the channel between the floating molding strip and a bottom wall of the channel.

14. The console for a vehicle of claim 13, wherein the biasing member includes at least one of a coiled spring and an elastomer material.

15. The console for a vehicle of claim 11, wherein the floating molding strip includes an external surface having a first portion and an opposite second portion slidably engaging a first and second channel wall, respectively.

16. A console for a vehicle, comprising:
a storage bin having a perimeter surface defining an opening;
a pivotable lid hinged on the storage bin proximal to a side of the perimeter surface such that a gap space is defined between the pivotable lid and the side of the perimeter surface;
a channel defined along the side of the perimeter surface;
a molding strip floatingly disposed within the channel; and
a biasing member urging a portion of the molding strip to extend out of the channel and against the pivotable lid such that the gap space is occupied by the portion of the molding strip.

17. The console of claim 16, further including a molding panel having an interior surface cooperating with the perimeter surface to define the channel.

18. The console of claim 17, wherein:
the perimeter surface includes a first vertical surface transitioning to a horizontal surface transitioning to a second vertical surface, and
the second vertical surface engages the interior surface of the interior molding panel such that the channel is defined by first vertical surface, the interior surface facing the first vertical surface, and the horizontal surface interconnecting the first vertical surface and the interior surface.

19. The console of claim 17, wherein the pivotable lid includes a cam surface in contact with the molding strip urging the molding strip to retract into the channel as the pivotable lid is pivoted from one of a first position and a second position to the other of the first position and the second position.

20. The console of claim 17, wherein the biasing member is a coil spring under compression, the coil spring includes a first end engaged to the horizontal surface and an opposite second end engaging an interior surface of the molding strip.
